(19) United States
(12) Patent Application Publication
(10) Pub. No.: US 2009/0254694 A1
(43) Pub. Date: Oct. 8, 2009

(54) MEMORY DEVICE WITH INTEGRATED PARALLEL PROCESSING

(75) Inventors: Eli Ehrman, Beth Shemesh (IL); Yoav Lavi, Raanana (IL); Avidan Akerib, Tel-Aviv (IL)

Correspondence Address: DARBY & DARBY P.C., P.O. BOX 770, Church Street Station, New York, NY, 10008-0770, US

(73) Assignee: ZIKBIT LTD., Netanya (IL)

(21) Appl. No.: 12/113,475

(22) Filed: May 1, 2008

Related U.S. Application Data
(60) Provisional application No. 61/072,931, filed on Apr. 2, 2008.

(51) Int. Cl. G06F 12/00

(52) U.S. Cl. 711/100; 711/E12.001

(57) ABSTRACT

A method for data processing includes accepting input data words including bits for storage in a memory, which includes multiple memory cells arranged in rows and columns. The accepted data words are stored so that the bits of each data word are stored in more than a single row of the memory. A data processing operation is performed on the stored data words by applying a sequence of one or more bit-wise operations to at least one row of the memory, so as to produce a result that is stored in one or more of the rows of the memory.

### CROSS-REFERENCE TO RELATED APPLICATIONS

This application claims the benefit of a U.S. Provisional Patent Application entitled “Memory Plus—Memory with Integrated Processing,” filed Apr. 2, 2008, whose disclosure is incorporated herein by reference.

### FIELD OF THE INVENTION

The present invention relates generally to data processing, and particularly to methods and systems for performing parallel data processing in memory devices.

### BACKGROUND OF THE INVENTION

Various methods and systems are known in the art for searching and accessing data that is stored in memory. Some known methods and systems use content-addressable techniques, in which the data is addressed by its content rather by its storage address. For example, U.S. Patent Application Publication 2007/0195570, whose disclosure is incorporated herein by reference, describes a technique for implementing a Content-Addressable Memory (CAM) function using traditional memory, where the input data is serially loaded into a serial CAM. Various additions, which allow for predicting the result of a serial CAM access coincident with the completion of serially inputting the data are also presented.

U.S. Pat. No. 6,839,800, whose disclosure is incorporated herein by reference, describes a RAM-Based Range Content Addressable Memory (RCAM), which stores range key Entries that represent ranges of integers and associated data entries that correspond uniquely to these ranges. The RCAM stores a plurality of range boundary information in a first array, and a plurality of associated data entries in a second array. In some embodiments, the first array is transposed.

PCT International Publication WO 2001/91132 describes an implementation of a CAM using a RAM cell structure. The publication describes a method of arranging and storing data for a CAM, which includes providing a two-dimensional array of memory cells, arranging keys in rows of ascending order starting from an edge column, and logically seeking a match.

A parallel architecture for machine vision, which is based on an associative processing approach, is described in a PhD thesis by Akerib, entitled “Associative Real-Time Vision Machine,” Department of Applied Mathematics and Computer Science, Weizmann Institute of Science, Rehovot, Israel, March, 1992, which is incorporated herein by reference.

### SUMMARY OF THE INVENTION

Embodiments of the present invention provide a method for data processing, including:

accepting input data words including bits for storage in a memory that includes multiple memory cells arranged in rows and columns;

storing the accepted data words so that the bits of each data word are stored in more than a single row of the memory; and

performing a data processing operation on the stored data words by applying a sequence of one or more bit-wise operations to at least one row of the memory, so as to produce a result that is stored in one or more of the rows of the memory.

In some embodiments, storing the input data words includes transposing the input data words. In an embodiment, storing the input data words includes initially writing the accepted data words to a first set of source rows of the memory, the transposed data words are stored in a second set of destination rows of the memory, and transposing the data words includes reading the source rows sequentially and copying bits of the data words from each read source row to the destination rows. In some embodiments, at least the one or more of the rows storing the result are transposed, so as to provide at least one output data word in a respective row of the memory.

In a disclosed embodiment, applying the sequence of the bit-wise operations includes:

identifying subsets of the columns, such that for each column in a given subset, a sub-column of bits belonging to the column and to the at least one row matches an input bit pattern that is associated with the given subset; and

for each subset, writing a respective output bit pattern mapped to the input bit pattern associated with the subset to the memory cells of the one or more of the rows in the columns of the subset.

Writing the output bit pattern may include determining the output bit pattern responsively to the input bit pattern by looking-up a truth table that maps input bit patterns to respective output bit patterns. In an embodiment, looking-up the truth table includes determining the output bit patterns for the respective columns by querying the truth table in parallel using the respective input bit patterns.

In another embodiment, identifying the subsets includes setting bits of a tag memory that correspond to the columns of a given subset, and writing the output bit pattern mapped to the input bit pattern associated with the given subset includes writing the output bit pattern to the columns for which the bits of the tag memory have been set. In some embodiments, the tag memory includes one of a hardware register and a designated row of the memory.

Writing the output bit pattern may include performing at least one selective writing operation selected from a group of operations consisting of:

writing a “1” value to the columns for which the bits of the tag memory have been set; and

writing a “0” value to the columns for which the bits of the tag memory have been set.

In some embodiment, the data processing operation includes one of a logical operation, an arithmetic operation, a conditional execution operation and a flow control operation.

In an embodiment, the method includes receiving a request, classifying the request to one of a first type of requests for performing parallel data processing operations and a second type of requests for performing memory access operations on the memory, performing the data processing operation responsively to classifying the request to the first type and performing the memory access operation responsively to classifying the request to the second type. Classifying the request may include extracting an address from the request and classifying the request based on the extracted address.

In some embodiments, applying the bit-wise operations includes performing at least one bit-wise operation selected from a group of operations consisting of:

copying bits from a row of the memory to respective bits of a tag memory;

copying the bits of the tag memory to the respective bits of the row of the memory;

reading the bits from the row of the memory, performing a bit-wise AND operation between the read bits and the respective bits of the tag memory, and writing respective output bits of the bit-wise AND operation to the bits of the tag memory;

reading the bits from the row of the memory, performing a bit-wise OR operation between the read bits and the respective bits of the tag memory, and writing respective output bits of the bit-wise OR operation to the bits of the tag memory; and

reading the bits from the row of the memory, applying bit-wise inversion to the read bits, performing a bit-wise AND operation between the inverted bits and the respective bits of the tag memory, and writing the respective output bits of the bit-wise AND operation to the bits of the tag memory.

Additionally or alternatively, applying the bit-wise operations may include performing at least one bit-wise operation selected from a group of operations consisting of:

setting a row of the memory to all “0”s or to all “1”s;

conditionally setting a group of bits in a row of the memory to all “0”s or to all “1”s responsively to respective bits of a tag memory; and

applying a bit-wise shift to the bits of the tag memory.

Further additionally or alternatively, applying the bit-wise operations may include addressing a group of bits in a row of the memory by setting a corresponding group of bits in a tag memory and performing a bit-wise operation that is defined conditionally on values of the bits of the tag memory.

In some embodiments, the memory includes multiple memory banks, the at least one row includes multiple rows that are stored in respective, different memory banks, and performing the data processing operation includes applying the bit-wise operations to the multiple rows in a single instruction cycle. In an embodiment, applying the bit-wise operation includes reading first and second rows from respective, different first and second memory banks, and performing a bit-wise AND operation between corresponding bits in the first and second rows. The method may include inverting the bits of one or both of the first and second rows prior to performing the bit-wise AND operation. The method may include writing an output of the bit-wise AND operation to a tag memory.

In some embodiment, the method includes storing an output of the bit-wise AND operation to one of:

one of the rows of the first memory bank;

one of the rows of the second memory bank; and

one of the rows of a third memory bank that is different from the first and second memory banks.

There is additionally provided, in accordance with an embodiment of the present invention, a method for data processing, including:

operating a memory device in a first operational mode for performing parallel data processing operations and in a second operational mode for performing memory access operations;

receiving a request, which specifies an address, for performing an operation on data stored in the memory device;

extracting the address from the request and selecting one of the first and second operational modes responsively to the extracted address; and

performing the requested operation by the memory device using the selected operational mode.

In some embodiments, operating the memory device includes predefining respective first and second address ranges for the first and second operational modes, and selecting the one of the operational modes includes determining one of the predefined address ranges in which the extracted address falls, and selecting the corresponding operational mode.

There is further provided, in accordance with an embodiment of the present invention, a data processing apparatus, including:

a memory, which includes multiple memory cells arranged in rows and columns; and

control circuitry, which is connected to the memory and is coupled to accept input data words including bits for storage in the memory, to store the accepted data words so that the bits of each data word are stored in more than a single row of the memory, and to perform a data processing operation on the stored data words by applying a sequence of one or more bit-wise operations to at least one row of the memory, so as to produce a result that is stored in one or more of the rows of the memory.

In some embodiments, the memory includes multiple memory banks, the at least one row includes multiple rows that are stored in respective, different memory banks, and the control circuitry is coupled to apply the bit-wise operations to the multiple rows in a single instruction cycle. In a disclosed embodiment, the control circuitry includes combining circuitry, which is operative to access multiple rows of the respective memory banks, to conditionally apply bit-wise inversion to one or more of the multiple rows, and to perform a bit-wise AND operation among the conditionally-inverted rows so as to produce the result. In another embodiment, the combining circuitry is operative to write the result to a tag memory. In yet another embodiment, the combining circuitry is operative to write the result to one of the multiple memory banks.

In still another embodiment, the control circuitry includes multiple bit processing circuits that are associated with the respective columns of the memory and are coupled to concurrently perform the bit-wise operations. In some embodiments, the apparatus includes a semiconductor die, and the memory and the control circuitry are fabricated on the semiconductor die. In some embodiments, the apparatus includes a device package, and the memory and the control circuitry are packaged in the device package.

There is also provided, in accordance with an embodiment of the present invention, a data processing apparatus, including:

a memory; and

control circuitry, which is connected to the memory and is coupled to operate in a first operational mode for performing parallel data processing operations and in a second operational mode for performing memory access operations, to receive a request, which specifies an address, for performing an operation on data stored in the memory, to extract the address from the request, to select one of the first and second operational modes responsively to the extracted address, and to perform the requested operation using the selected operational mode.

There is additionally provided, in accordance with an embodiment of the present invention, a computer software product for data processing, the product including a tangible computer-readable medium in which program instructions are stored, which instructions, when read by a computer that is connected to a memory that includes multiple memory cells arranged in rows and columns, cause the computer to accept input data words including bits for storage in the memory, to store the accepted data words so that the bits of each data word are stored in more than a single row of the memory, and to perform a data processing operation on the stored data words by applying a sequence of one or more bit-wise operations to at least one row of the memory, so as to produce a result that is stored in one or more of the rows of the memory.

There is further provided, in accordance with an embodiment of the present invention, a computer software product for data processing, the product including a tangible computer-readable medium in which program instructions are stored, which instructions, when read by a computer that is connected to a memory, cause the computer to operate in a first operational mode for performing parallel data processing operations and in a second operational mode for performing memory access operations, to receive a request, which specifies an address, for performing an operation on data stored in the memory, to extract the address from the request, to select one of the first and second operational modes responsively to the extracted address, and to perform the requested operation using the selected operational mode.

The present invention will be more fully understood from the following detailed description of the embodiments thereof, taken together with the drawings in which:

### BRIEF DESCRIPTION OF THE DRAWINGS

FIG. 1 is schematic illustration demonstrating the concept of parallel processing using a truth table, in accordance with an embodiment of the present invention;

FIG. 2 is a schematic illustration of a memory array storing data in a column-wise orientation, in accordance with an embodiment of the present invention;

FIG. 3 is a block diagram that schematically illustrates a system for data storage and processing, in accordance with an embodiment of the present invention;

FIG. 4 is a flow chart that schematically illustrates a method for parallel data processing, in accordance with an embodiment of the present invention;

FIG. 5 is a schematic illustration showing a method for transposing data from row-wise to column-wise orientation, in accordance with an embodiment of the present invention;

FIG. 6 is a flow chart that schematically illustrates a method for transposing data from row-wise to column-wise orientation, in accordance with an embodiment of the present invention;

FIG. 7 is a flow chart that schematically illustrates a method for dual-mode operation of a system for data storage and processing, in accordance with an embodiment of the present invention; and

FIG. 8 is a block diagram that schematically illustrates a system for data storage and processing, in accordance with an alternative embodiment of the present invention.

### DETAILED DESCRIPTION OF EMBODIMENTS

### Overview

A wide variety of data processing operations can be represented as sequences of bit-wise operations that are applied to multi-bit data words. Such data processing applications may comprise, for example, Boolean, arithmetic, conditional execution and flow control operations. Since such operations are used as basic building blocks in many data processing applications, efficient parallel implementation of bit-wise operations may considerably enhance the performance of these applications.

Embodiments of the present invention provide improved methods and systems for performing parallel data processing operations on data words. In some embodiments that are described hereinbelow, a data processing system comprises a processor, a memory and associated control logic. In some disclosed configurations, the control logic is fabricated on the same semiconductor die as the memory array, or packaged in the same device, to form a “computational memory” unit. The computational memory unit performs highly-parallel data processing operations on behalf of the processor, while communicating with the processor over a conventional bus interface. In some embodiments, the memory comprises a conventional memory array, and the parallel processing operations are performed with only minimal addition of hardware. Additionally or alternatively, the computational memory unit may support dual-mode operation, performing some operations (e.g., conventional memory access operations) in a conventional serial mode and other operations (e.g., parallel processing capabilities in addition to memory storage) in a parallel mode.

The memory comprises an array of memory cells that are arranged in rows and columns. The memory typically has a conventional architecture in which data words are written and read in a row-wise orientation. The memory cells along each row of the memory are addressed by a common word line, and the memory cells along each column are connected to a common bit line. In a conventional write operation, a group of cells in a given row is programmed simultaneously by addressing the appropriate word line. In a conventional read operation, a group of cells in a given row are read simultaneously by addressing the appropriate word line and sensing the bit lines corresponding to the columns in which the cells are located.

Input data for processing, which comprises a plurality of data words, is initially stored in the memory in a row-wise orientation. Each data word comprises multiple bits that are arranged in order of significance, from the Least Significant Bit (LSB) to the Most Significant Bit (MSB). The location of a given bit in the data word is referred to herein as the order of the bit. A bit-wise operation manipulates a given set of bits of one or more input data words to produce a result, which may comprise one or more bits.

In order to perform data processing operations efficiently on multiple data words in parallel, the system transposes the input data words, so as to arrange them in a column-wise orientation in the memory. After transposing the data words, each row of the array stores corresponding bits of a given order from different data words. In the transposed, column-wise orientation, parallel bit-wise operations on data words are equivalent to bit-wise operations on rows of the array.

The system carries out a data processing operation, which is represented by a sequence of bit-wise operations on bits of the data words, by performing a sequence of bit-wise operations on rows of the memory array. In particular, interim results of bit-wise operations can be stored in rows of the array and can be used as input for subsequent bit-wise operations. In some embodiments, the bit-wise operations are implemented by a parallel look-up in a truth table.

After performing the data processing operation, the system transposes the stored data back to the row-wise orientation, in which the data words are disposed along rows of the array. The results of the data processing operation are then read out of the array in a conventional row-wise manner.

Since the architecture of a conventional memory array lends itself to efficient operation on rows, transposing the input data words to a column-wise orientation enables the methods and system described herein to achieve high efficiency in performing parallel, vector operations on multiple data words. These methods and systems are particularly suitable for use with conventional memory array architectures that address data in a row-by-row fashion, with only minimal addition of hardware to the memory array itself. Several system configurations, having different partitioning between software and hardware, are described hereinbelow.

In dual-mode operation, the parallel processing methods described herein do not compromise the efficiency of using the memory for conventional read and write operations. In some embodiments, the benefits of the computational memory can be achieved without modifying the instruction set that is used for controlling the memory to perform conventional read and write operations.

### Parallel Processing Using Truth Tables

Before describing the disclosed methods and systems in detail, some background explanation regarding the concept of performing bit-wise operations using parallel truth tables will be provided.

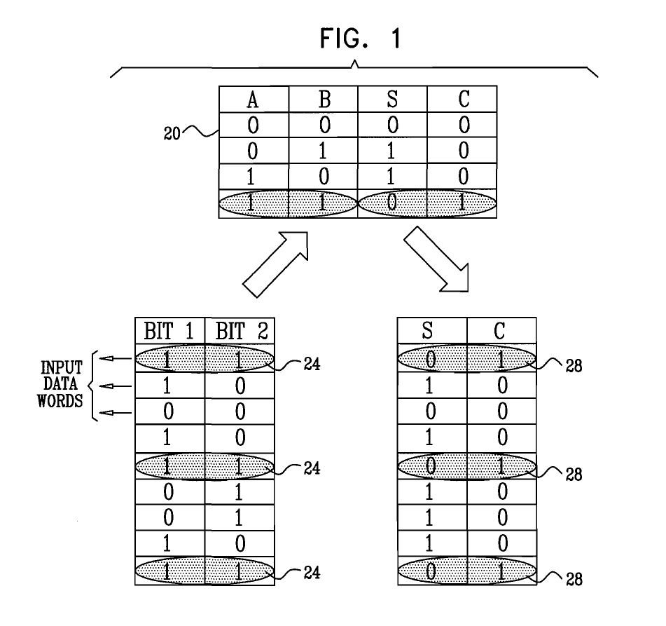

FIG. 1 is schematic illustration demonstrating the concept of parallel processing using a truth table 20, in accordance with an embodiment of the present invention. In the present example, the data processing operation comprises summations of pairs of bits along each data word. The present example demonstrates a technique for performing the bit-wise summation in parallel, over a large plurality of data words. The bit-wise summation operation is defined by truth table 20. According to table 20, input bits A and B of a given data word are summed to produce a sum bit S and a carry bit C. The bit-wise summation operation produces two result vectors that store the sum and carry values of the corresponding bit pairs.

The bit-wise summation is applied in parallel to two bits (denoted “BIT 1” and “BIT 2”) in a large plurality of data words. The operation can be carried out in parallel by (1) identifying all bit pairs having a given set of bit values, (2) looking up truth table 20 to determine the values of the sum and carry bits that correspond to this set of bit values, and (3) setting the sum and carry values in the result vectors to the values retrieved from the truth table. This process is repeated over all possible bit values.

For example, the figure shows bit pairs 24 in the input data words that are equal to {1,1}. According to truth table 20, the corresponding sum value for these bit pairs is 0 and the corresponding carry value is 1. Thus, the sum and carry values of the result vectors are set to 0 and 1, respectively. The figure shows bit pairs 28 in the result vectors that correspond to bit pairs 24 in the input data words.

Similarly, for every {0,0} bit pair in the input data words, the corresponding {sum, carry} values in the result vectors are set to {0,0}. For every {0,1} bit pair in the input data words, the corresponding {sum, carry} values are set to {1,0}. For every {1,0} bit pair in the input data words, the {sum, carry} values are set to {1,0}, as defined by truth table 20.

Note that the input may comprise thousands or even millions of input data words. Nevertheless, the bit-wise operation is carried out using only four parallel truth table look-up operations, regardless of the number of input data words. The concept of performing bit-wise operations using parallel truth tables can be used to perform any other bit-wise operation.

In the example of FIG. 1, the truth table had a two-bit input and a two-bit output. In alternative embodiments, however, truth tables can have any suitable number of input bits and any suitable number of output bits. For example, a truth table can define an operation between two multi-bit vectors (each represented by two or more bits), to produce a multiple-bit result vector. A parallel bit-wise operation can thus be generalized and defined as a mapping operation that maps a certain pattern of input bit values to a certain pattern of output bit values. Alternatively to using truth tables, mapping the input bit patterns to the desired output bit patterns may be carried out using any other suitable function, circuitry or data structure.

Generally, a truth table may comprise M input bits, N output bits and K entries. (The number of entries K may sometimes be smaller than 2^{M}, since some bit value combinations of the input bits may be invalid or restricted.) In many cases, a large and complex truth table can be broken down into an equivalent set of smaller and simpler truth tables.

Thus, any suitable data processing operation (any Turing machine, as is known in the art) that operates on a set of input data vectors can be represented as a set of bit-wise operations, which in turn can be carried out by looking-up one or more parallel truth tables.

### Bit-Wise Operations Using Data Transposition

In the description of FIG. 1 above, bits of a given order are associated with columns, and the bit-wise operation is applied to vertical columns in parallel. In most conventional memory devices and computing devices, however, data is stored and read and operations are performed in a row-wise manner. In order to perform bit-wise operations efficiently using conventional memory arrays, the methods and systems described herein transpose the input data words, so as to arrange them in a column-wise orientation in the memory.

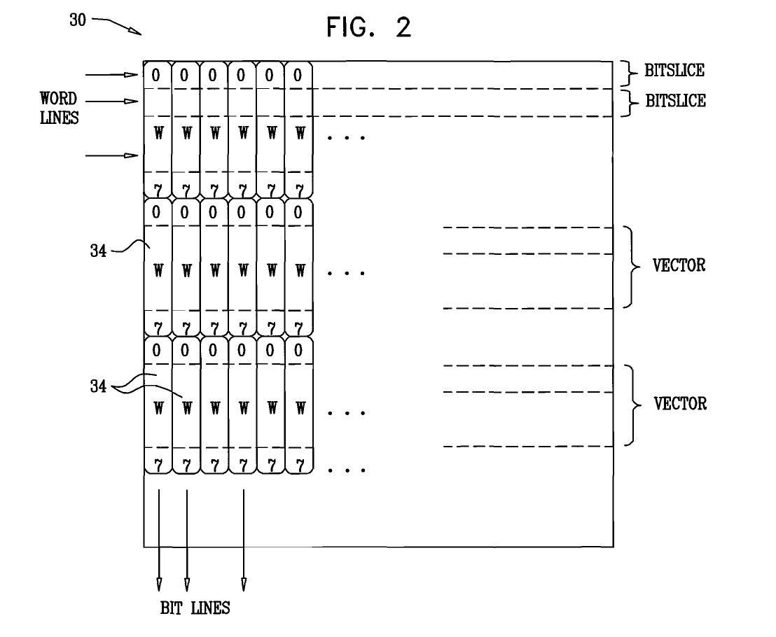

FIG. 2 is a schematic illustration of a memory array 30 storing data in a column-wise orientation, in accordance with an embodiment of the present invention. Array 30 comprises multiple memory cells that store respective data bits. The terms “memory cells” and “bits” are used herein interchangeably for the sake of clarity. Nevertheless, the methods and systems described herein can be generalized to operate with multi-level memory technologies, in which each memory cell stores more than one bit. In these embodiments, truth table entries may take non-Boolean values (e.g., {0 . . . 3} or {0 . . . 7}).

Array 30 is arranged in rows and columns. The rows are commonly referred to as word lines, and the columns are commonly referred to as bit lines. In a typical memory array, data is written to the memory in a row-wise manner, so that data words are laid along the rows of the array. Similarly, conventional read operations read data from the memory in a row-wise manner, i.e., read the data from a given word line.

In order to perform bit-wise operations on multiple data words in parallel using row-wise read and write commands, the methods and systems described herein transpose the input data words. In the context of the present patent application and in the claims, the term “transposing” refers to any operation that converts data words from a row-wise orientation to a column-wise orientation, so that the bits of a given data word are stored in more than a single row of the memory. In some transposition operations, each transposed data word lies in a single column of the array. Transposition is not limited, however, to placing each transposed data word in a single column. For example, an eight-bit data word may be transposed to four two-bit rows.

FIG. 2 shows input data words 34 after an exemplary transposition operation. As can be seen in the figure, data words 34 are arranged in a column-wise orientation in array 30. In the present example, each word comprises eight bits, although any other suitable word length can be used. In the column-wise orientation, each row of the array stores bits of a given order that belong to different words. A row storing bits of a given order is referred to herein as a bitslice. A vector is defined herein as a set of multiple bitslices. The bitslices that form a given vector may be located in consecutive or non-consecutive rows in the array. Each column of a given vector is referred to as an element of the vector.

In the column-wise orientation, bit-wise operations on data words can be carried out in parallel by performing parallel bit-wise operations on rows of the array. Referring to FIG. 2, for example, a bit-wise logical OR between the first and eighth rows of array 30 actually computes in parallel a bit-wise logical OR between the LSBs and MSBs of all the words stored in the first eight rows of the array. The result can be stored in another row of the array for further processing. Bit-wise operations may be performed between single bitslices, such as in the simple OR example above. In some embodiments, however, bit-wise operations can be defined between vectors, with each vector comprising one or more bitslices.

### Example Hardware Configuration

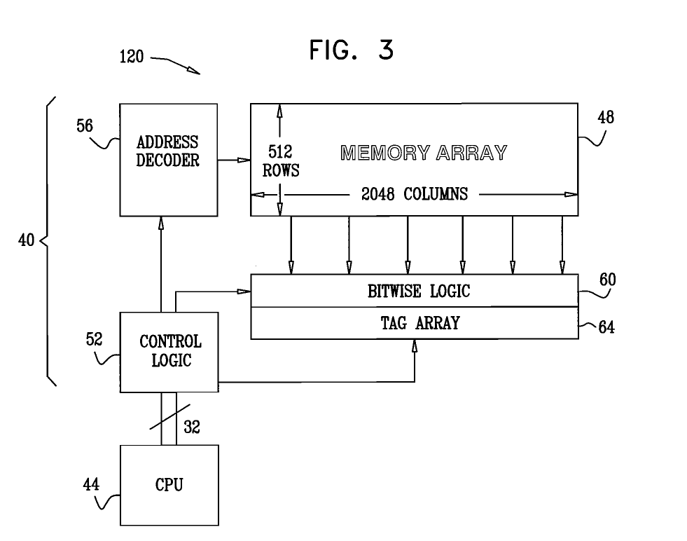

FIG. 3 is a block diagram that schematically illustrates a system 40 for data storage and processing, in accordance with an embodiment of the present invention. System 40 stores data and performs parallel data processing operations on behalf of a Central Processing Unit (CPU) 44. System 40 comprises a memory array 48, which is similar to array 30 of FIG. 2 above. In the present example, array 48 comprises 2048 columns (bit lines) and 512 rows (word lines), although any other suitable dimensions can be used. The memory array may comprise any suitable memory technology, such as Static Random Access Memory (SRAM), Dynamic RAM (DRAM) or Flash memory. In some embodiments, memory array 48 and address decoder 56 may comprise known, conventional hardware units.

The configuration of FIG. 3 enables system 40 to operate with conventional CPUs using conventional bus interfaces, and still provide the enhanced processing functionality described herein. In some embodiments, system 40 supports dual-mode operation. In this type of operation, the system supports both conventional (serial) memory access operations and parallel operations. Dual-mode operation and several alternative hardware configurations are described and discussed further below.

CPU 44 provides data words for storage and processing to Control logic 52, in the present example over a 32-bit bus interface. The control logic accepts the data words from the CPU and carries out the parallel data processing methods described herein. In particular, the control logic transposes the data words to column-wise orientation, manages the performing of bit-wise operations between rows of the array, transposes the data back to row-wise orientation and returns the results to the CPU. System 40 further comprises an address decoder 56, which decodes word line addresses for storage and retrieval of data in and out of array 48.

The bit-wise operations between rows of array 48 are performed by bit-wise logic 60. In some embodiments, bit-wise logic 60 applies a truth table look-up function per each column (bit line) of array 48. Alternatively, however, logic 60 may apply any suitable bit-wise logic function to a given set of bits along the respective bit line. The bit-wise logic can be viewed as a set of multiple bit processors, one bit processor associated with each column of the memory. Each bit processor may perform truth table lookup or any other bit-wise operation on a given set of bits along the respective bit line. In some implementations, the bit processors may comprise Arithmetic Logic Units (ALUs) that perform various arithmetic operations.

In some embodiments, the system comprises a tag array 64. The tag array comprises a tag flag (bit) per each column, which is used for storing interim results and for marking specific columns during operation, as will be explained below.

The system configuration of FIG. 3 is an exemplary configuration, which is chosen purely for the sake of conceptual clarity. Any other suitable configuration can be used for implementing the methods and systems described herein. The address decoder, control logic, bit-wise logic and tag array are regarded as a control circuit, which is connected to the memory array and carries out the methods described herein.

In some embodiments, the control logic, bit-wise logic and tag array are fabricated on the same semiconductor die as the memory array. Alternatively, the different components of system 40 may be fabricated on two or more dies and packaged in a single package, such as in a System on Chip (SoC) or Multi-Chip Package (MCP). Any of the control logic or the controller may be split into two or more components. For example, the CPU may be off-chip and communicate with the control logic directly. As another example, the system may comprise a sequencer that receives a single instruction and in response sends multiple instructions to the control logic.

Thus, in some embodiments, system 40 is regarded as a “computational memory” unit, which carries out both storage functions and parallel data processing functions on the stored data. The computational memory unit may operate under the control of conventional CPUs using conventional bus interfaces.

In alternative embodiments, the methods and systems described herein can be implemented using suitable software running on CPU 44. In these embodiments, the control logic, bit-wise logic and tag array can be omitted and replaced with equivalent software functions and/or data structures. In some embodiments, CPU 44 and/or control logic 52 comprise general-purpose processors, which are programmed in software to carry out the functions described herein. The software may be downloaded to the processors in electronic form, over a network, for example, or it may alternatively be supplied to the computer on tangible media, such as CD-ROM.

### Expressing Data Processing Operations by a Sequence of Parallel COMPARE and WRITE Operations

As noted above, parallel data processing operations on multiple data words can be represented as sequences of bit-wise operations on rows of array 48, assuming the stored data words have been transposed to column-wise orientation. In particular, any data processing operation can be represented as a sequence of two types of parallel bit-wise operations on rows of array 48, denoted WRITE and COMPARE. The WRITE operation stores a given bit pattern into some or all elements of a given vector (i.e., into some or all of the columns of a single bitslice of the vector). The COMPARE operation compares the elements of a vector to a given bit pattern, and marks the vector elements that match the pattern.

In some embodiments, the WRITE operation stores the given bit pattern in all elements of the vector. Consider, for example, a 3-bit vector consisting of rows 10-12 of the array (after transposition), and assume that the WRITE operation is to write the bit pattern “101” (decimal 5) into each element of this vector. In other words, the WRITE operation is to set row 10 of the array to all “1”s, row 11 to all “0”s and row 12 to all “1”s. This operation is easily carried out using conventional memory access operations. In the example of FIG. 3, control logic 52 sets address decoder 56 to address row 10, and stores all “1”s data in this row. The control logic then increments the address value and stores all “0”s in row 11. The control logic increments the address again and stores all “1”s in row 12.

The example above can be implemented using the following C-language code, assuming a 32-bit wide memory:

| | |
|---|---|
| (1) | int * A; |
| (2) | int d; |
| (3) | A = 10; |
| (4) | d = 0xffff; |
| (5) | *A = d; |
| (6) | A = 10; |
| (7) | *A++ = 0xffff; |
| (8) | *A++ = 0X0; |
| (9) | *A = 0xffff; |

(The examples in this section assume 32-bit memory access. System configurations that exploit the higher number of columns of the memory array to achieve a higher degree of parallelism are addressed further below.)

In some embodiments, however, the WRITE operation is requested to write the bit pattern to only some of the vector elements. All other elements of the vector are to retain their previous values. This variant of the WRITE operation writes the bit pattern to the vector elements whose respective tag flags (i.e., the respective bits in tag array 64) are set to “1”. The vector elements whose tag flags are “0” retain their previous values.

The selective WRITE operation may be implemented by reading each row of the vector, selectively modifying the read row based on the tag flags, and re-writing the row into the memory. Alternately, a selective WRITE operation can be implemented by activating the WRITE on only some of the bitlines of the memory array. Consider, for example, an operation that writes the bit pattern “101” into only the first and fifth elements of a vector consisting of rows 10-12 of the array. The operation is given by the following C-language code:

| | |
|---|---|
| (10) | int tag = 0x11; // set binary bits 1 and 5 |
| (11) | A = 10; |
| (12) | d = *A; |
| (13) | d = tag \| (d & ~tag); |
| (14) | *A = d; |
| (15) | void awrite(int data, int * A, |
| | int NumBits, int tag) |
| (16) | { |
| (17) | int m = 1; |
| (18) | int d; |
| (19) | while (NumBits−−) { |
| (20) | d = *A; |
| (21) | if (data & m) { |
| (22) | d = tag \| (d & ~tag); |
| (23) | } |
| (24) | else { |
| (25) | d = d & ~tag; |
| (26) | } |
| (27) | *A = d; |
| (28) | m <<= 1; |
| (29) | A++; |
| (30) | } |
| (31) | } |

Line (13) above calculates the bit-wise complement of the tag array, and performs a bit-wise AND with the original content of the row. Thus, the original bit values are retained for the columns (vector elements) whose tag flags are “0”. A “1” bit value is stored in the columns whose tag flags are “1”.

The inputs to the selective “awrite” function comprise:
data—the bit pattern to be written to the vector elements whose tag is “1”.
A—the starting position of the vector, i.e., the row of the vector's LSB.
NumBits—the vector width in bits.
tag—the tag array, whose width is equal to the width of the memory array (32 bits in the present example).

The COMPARE operation compares the elements of a vector to a given bit pattern, and sets the tag flags of the elements whose content matches the bit pattern. In some embodiments, a pre-tag flag is maintained for each vector element. The rows forming the vector are scanned row-by-row. For each row, the bit value of each vector element in the row is compared to the corresponding bit value in the bit pattern. If the two values match, the pre-tag value of this vector element is set, otherwise it is reset. A bit-wise AND is calculated between the current and previous pre-tag values, so that only vector elements in which all pre-tag values are “1” will have their tag flag set at the end of the process.

The COMPARE operation can be implemented by the following C-language code:

| | |
|---|---|
| (32) | int acompare(int BitValues, int * |
| | PosArr[ ], int NumBits) |
| (33) | { |
| (34) | int * A; |
| (35) | int d, tag, i, m; |
| (36) | tag = ~0; |
| (37) | for (i=0, m=1; i < NumBits; i++, |
| | m <<= 1) { |
| (38) | A = PosArr[i]; |
| (39) | d = *A; |
| (40) | if (BitValues & m) { |
| (41) | tag &= d; |
| (42) | } |
| (43) | else { |
| (44) | tag &= ~d; |
| (45) | } |
| (46) | } |
| (47) | return tag; |
| (48) | } |

As noted above, the rows forming the vector need not necessarily be contiguous in the array. Additionally, the operation may compare only a subset of the rows forming the vector. The values passed to the “acompare” function above comprise:
NumBits—the number of bits (rows) to compare.
BitValues—the bit pattern for the participating bits.
PosArr—an array holding the positions of the participating bits. The array is NumBits long.

The function modifies the tag array, so that only the tag bits corresponding to vector elements that match the bit pattern are set.

A wide variety of data processing operations can be implemented using sequences of parallel COMPARE and WRITE functions. In particular, control logic 52 may carry out any parallel truth table operation using these functions. Consider a truth table that maps a certain input bit pattern to a certain output bit pattern. For each entry of the truth table, logic 52 performs a COMPARE operation that sets the tag flags of all vector elements matching the input bit pattern specified by the truth table entry. Logic 52 then performs a WRITE operation that writes the corresponding output bit pattern into another set of rows.

### Parallel Data Processing Method Description

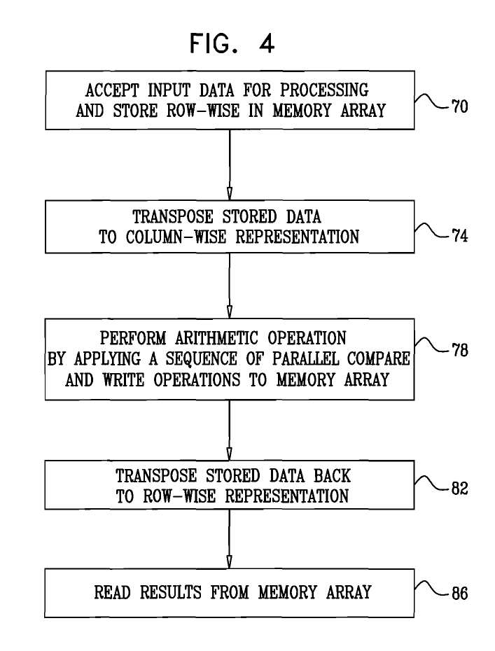

FIG. 4 is a flow chart that schematically illustrates a method for parallel data processing, in accordance with an embodiment of the present invention. The description that follows assumes that the method is carried out by control logic 52 of FIG. 3, in conjunction with bit-wise logic 60, tag array 64 and address decoder 56. Alternatively, however, the method can be carried out by any other suitable logic or processor (e.g., in CPU 44). The method can be implemented in hardware, in software, or as a combination of hardware and software elements.

The method begins with control logic 52 accepting input data comprising data words, at an input step 70. The control logic stores the input data in array 48 in a row-wise orientation, such that the data words are laid along rows of the memory array.

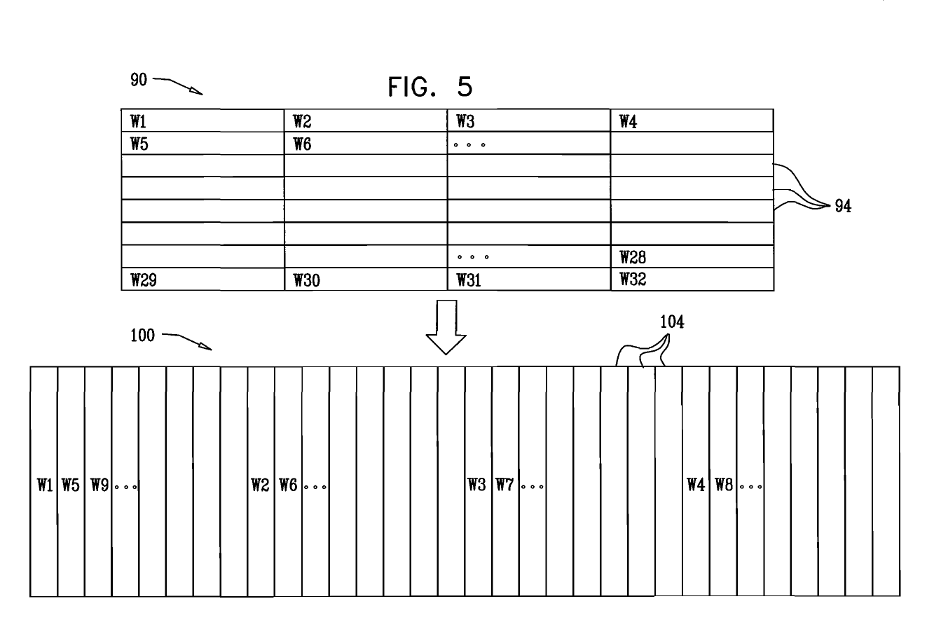

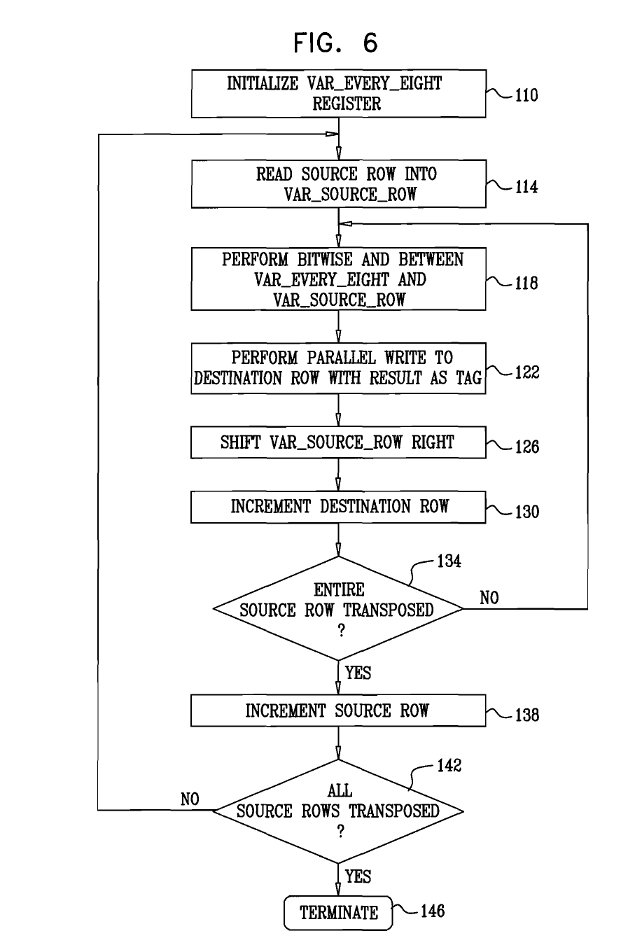

The control logic transposes the stored data words, at a transposing step 74. After transposing the data, the input data words are laid along columns of array 48, such that each row stores corresponding bits of a given order from different data words. An example of data words arranged in column-wise orientation is shown in FIG. 2 above. The control logic may use any suitable method for transposing the data. An exemplary method is shown in FIGS. 5 and 6 below.

After transposing the data, the control logic carries out a parallel data processing operation, at an operation step 78. The data processing operation may comprise a logical operation, an arithmetic operation, a conditional execution operation, a control flow operation, or any other operation that can be expressed as a sequence of bit-wise operations that are applied to the input data words. In some embodiments, the control logic performs the data processing operation by applying a sequence of parallel COMPARE and WRITE operations, as explained above. The result of the data processing operation is written in one or more rows of the memory array.

After performing the data processing operation, control logic 52 transposes the stored data back to a row-wise orientation, at a re-transposing step 82. Typically although not necessarily, the re-transposing operation is the same as the transposing operation carried out at step 74. The control logic then reads the results of the parallel data processing operation from array 48 and outputs the result to CPU 44, at an output step 86.

### Data Transposition Operation

FIGS. 5 and 6 below describe a method for transposing data, in accordance with an embodiment of the present invention. The method of FIGS. 5 and 6 can be used in steps 74 and 82 of FIG. 4 above.

FIG. 5 shows a source set 90 of input data words 94, which is transposed to produce a destination set 100 of transposed data words 104. In the present example, the input data words comprise thirty-two eight-bit data words denoted W1 . . . W32, which are laid out in a row-wise orientation. The input data words are transposed to form the output data words using the method of FIG. 6 below. The output data words are laid in a column-wise orientation, typically in a different location in the memory array.

As can be seen in the figure, the transposition process modifies the order of the output data words. However, when the method of FIG. 6 is used again to re-transpose the data words back to row-wise orientation, the order of the re-transposed data words is maintained.

FIG. 6 is a flow chart that schematically illustrates a method, which is carried out by control logic 52 for transposing data from row-wise to column-wise orientation, in accordance with an embodiment of the present invention. Alternatively, the method can be carried out by CPU 44 or other processor. The method transposes the four input words in the first row of source set 90 to four output words in columns 1, 9, 17 and 25 of destination set 100 in parallel. Then, the four input words in the second row of the source set are transposed in parallel to produce four output words in columns 2, 10, 18 and 26 of the destination set. The process is repeated until all rows of the source set have been transposed.

The method of FIG. 6 begins with logic 52 initializing a 32-bit register denoted VAR_EVERY_EIGHT, at an initialization step 110. Every eighth bit of register VAR_EVERY_EIGHT (i.e., bits 1, 9, 17 and 25) are set to “1”, and the other bits are set to “0”.

The control logic reads a row of the source set into a register denoted VAR_SOURCE_ROW, at a row reading step 114. The logic calculates a bit-wise AND between VAR_EVERY_EIGHT and VAR_SOURCE_ROW, at a row calculation step 118. The control logic uses the result of step 114 as the tag array, and performs a parallel WRITE operation to the corresponding row of the destination set, at a row writing step 122. The control logic then shifts VAR_SOURCE_ROW one position to the right, at a row shifting step 126. The control logic increments the destination row, at a destination row incrementing step 130.

The process is repeated eight times, until the entire source row has been transposed. The control logic checks whether the entire source row has been transposed, at an entire row checking step 134. If not, the method loops back to step 118 above. If the entire source row has been transposed, the control logic increments the source row, at a source row incrementing step 138.

The control logic checks whether all source rows have been transposed, at an all rows checking step 142. If all source rows have been transposed, the method terminates at a termination step 146. Otherwise, the method loops back to step 114 above, and the control logic reads and transposes the next source row. For each source row, the destination column is higher by one with respect to the previous source row.

The following C-language code implements the method of FIG. 6:

| | |
|---|---|
| (49) | void transpose(int * PosD, int* PosS, int |
| | NumRows, int NumBits) |
| (50) | { |
| (51) | int d, i, j, tag, m; |
| (52) | // build tag |
| (53) | for (i=0, m=1, tag=0; i<sizeof(int); |
| | i++) { |
| (54) | if ((i%NumBits)==0) { |
| (55) | tag \|= m; |
| (56) | } |
| (57) | } |
| (58) | int *S = PosS; |
| (59) | for (j=0; j<NumBits; j++, S++) { |
| (60) | int * A; |
| (61) | // take one row of source and |
| (62) | // transpose it so that there is |
| (63) | // one valid vector every |
| | NumBits columns |
| (64) | for (i=0, d = *S, A = PosD; |
| | i<NumBits; i++, d >>= 1, A++) } |
| (65) | awrite(0x1, A, 1, (tag & d) |
| | << j); |
| (66) | } |
| (67) | } |
| (68) | } |

This code uses the WRITE function “awrite” defined above. The inputs to the function “transpose” comprise:
PosD—the position of the first row of the destination set.
PosS—the position of the first row of the source set.
Numbits—the number of bits in each input data word (eight in the present example).

The code given above refers to a software-only implementation of the transposition operation, but this example was chosen purely for the sake of conceptual clarity. In embodiments in which transposition is carried out in hardware (or by a combination of hardware and software functions), the VAR_EVERY_EIGHT pattern may be stored in a certain bitslice of the memory array, and the transposition operation may be implemented using only COMPARE and WRITE operations without additional registers or additional functionality of the control logic.

### Data Processing Operation Examples

To summarize the description, the following C-language code provides a function that implements a summation of two vectors, using the methods described above:

| | |
|---|---|
| (69) | void Plus (int * PosO, int * PosL, int * |
| | PosR, int * PosC1, int * PosC2, int Len) |
| (70) | { |
| (71) | vzero(PosO, Len); |
| (72) | vzero(PosC, 1); |
| (73) | |
| (74) | int * CPosArr[3] = |
| | {PosR, PosL, PosC1}; |
| (75) | int * WPosArr[3] = {PosO, PosC2}; |
| (76) | |
| (77) | for (int Col=0; Col<Len; Col++) { |
| (78) | acompare(0x0, CPosArr, 3); |
| (79) | awrite(0x0, WPosArr, 2); |
| (80) | acompare(0x1, CPosArr, 3); |
| (81) | awrite(0x1, WPosArr, 2); |
| (82) | acompare(0x2, CPosArr, 3); |
| (83) | awrite(0x1, WPosArr, 2); |
| (84) | acompare(0x3, CPosArr, 3); |
| (85) | awrite(0x2, WPosArr, 2); |
| (86) | acompare(0x4, CPosArr, 3); |
| (87) | awrite(0x1, WPosArr, 2); |
| (88) | acompare(0x5, CPosArr, 3); |
| (89) | awrite(0x2, WPosArr, 2); |
| (90) | acompare(0x6, CPosArr, 3); |
| (91) | awrite(0x2, WPosArr, 2); |
| (92) | acompare(0x7, CPosArr, 3); |
| (93) | awrite(0x3, WPosArr, 2); |
| (94) | vcopy(C1, C2, 1); |
| (95) | CPosArr[0]++; |
| (96) | CPosArr[1]++; |
| (97) | WPosArr[0]++; |
| (98) | } |
| (99) | } |

The “plus” function can be used, for example, to add a constant value of 3 to a set of input data words in an efficient, parallel manner. In order to perform this parallel operation, the function can be used as follows:
Start with a set of input data words in a row-wise orientation.
Transpose the input data words to column-wise orientation.
Create an 8-bit wide vector using the “awrite” function, such that all vector elements have the value 3 (binary “011”).
Create an empty, 8-bit wide result vector. Allocate two 1-bit carry vectors.
Call the “plus” function.
Transpose the result vector back to row-wise orientation. The result comprises the original set of input data words, each increased by 3.

The code above demonstrates a summation operation. In alternative embodiments, various other kinds of data processing operations (e.g., logical operators, arithmetic operations, conditional execution and flow control operations) can be defined and carried out using the methods described herein.

### Additional Hardware Considerations

In the description of FIG. 3 above, the interface connecting CPU 44 with system 40 comprises a 32-bit bus, and the data words provided by the CPU comprise 32-bit words. Memory array 48, on the other hand, comprises 2048 bit lines. Thus, given an appropriate addressing scheme, multiple input data words can be stored in each row of array 48, and then transposed and processed using the methods described herein.

In some embodiments, control logic 52 selects the appropriate position for each 32-bit data word within the 2048-bit row of the array. For example, the address sent by the CPU can be broken into a 9-bit Row Address Select (RAS) field and a 6-bit field that positions the desired 32-bit data word within the 2048-bit row. This technique can be used, for example, when the methods described herein are carried out in software by the CPU. In alternative embodiments, such as when the data words are not sent back and forth to and from the CPU, all 2048 bits can be processed in parallel. This feature is accomplished using the tag array, which stores interim results.

System 40 supports a number of operations for implementing the parallel processing methods described herein. In particular, these operations enable system 40 to apply parallel WRITE and COMPARE operations described above to entire 2048-bit rows.

In some embodiments, system 40 supports a parallel read COPY operation. The COPY operation reads all 2048 data bits from a given row (word line) of array 48, and copies them into tag array 64. The COPY operation can be written as:

Tag=Memory (Row)

System 40 further supports a parallel read AND operation. The READ operation reads all 2048 data bits from a given row of array 48, executes a bit-wise parallel AND operation between the read row and the current content of the tag array, and writes the result of the bit-wise AND operation back to the tag array. This operation can be written as:

Tag=Tag & Memory (Row)

The parallel AND operation can be used to implement a parallel COMPARE. Consider, for example, the first four rows of array 48. In the column-wise representation discussed above, these four rows are regarded as a vector of 2048 4-bit elements. The parallel COMPARE operation identifies and marks the elements whose content matches a given 4-bit pattern. Consider, for example, the binary pattern “1111”.

In an exemplary implementation of the parallel COMPARE operation, control logic 52 initializes the tag array to all “0”s, and then performs a parallel read AND operation four times. In the first AND operation, the row address is specified as 0 (the first row of array 48). In the second, third and fourth AND operations the row address is set to 1, 2 and 3, respectively. The resulting tag array will contain “1” for all the columns in which all the bits in the first four rows are “1”, i.e., for all the vector elements that match the “1111” pattern. In some embodiments, bit-wise logic 60 comprises an AND gate or equivalent logic per each bit line, for implementing the parallel AND operation.

As another example, consider a parallel COMPARE operation with a “1010” bit pattern. In order to identify this pattern, and in order to provide a fully-functional COMPARE operation that is able to match any desired bit pattern, bit-wise logic 60 further comprises an inverter (logical NOT) per each bit line. System 40 thus supports a parallel read INVADD operation, which reads a given row from the memory array, inverts all bits and then performs a bit-wise AND operation with the content of the tag Array. The result is written back into the tag Array. The parallel read INVADD operation can be written as:

Tag=Tag & ˜Memory (Row)

The parallel COMPARE operation can be implemented by selecting the ADD and INVADD operations according to the desired bit pattern for comparison. For example, in order to identify the vector elements that match the pattern “1010”, logic 52 and logic 60 execute the following operations:

Tag=Tag & ˜Memory (0)

Tag=Tag & Memory (1)

Tag=Tag & ˜Memory (0)

Tag=Tag & Memory (1)

After executing these operations, the tag Array will contain “1” for the elements whose content matches the “1010” pattern. The inversion operation can be implemented with an exclusive OR (XOR) gate per each bit line. The XOR gate has two inputs. One input accepts the data bit read from memory. The other input accepts a control line from logic 52, which is set to “1” when the bit value is to be inverted. The tag bit comprises an AND gate, which accepts its previous value at one input and the output of the XOR gate at its other input. The parallel COMPARE can thus be implemented using bit-wise logic comprising a single storage/register bit for the tag flag, an ADD and a XOR gate per bit line.

System 40 further supports a parallel WRITE operation. In some embodiments, logic 52 and logic 60 support a parallel write SETBYTAG operation, which sets selective bits in a given row of array 48 to either “1” or “0” only if the corresponding bit of the tag array is set. If the corresponding tag array bit is not set, the values of the corresponding bits in the given row are left unchanged. Selective setting of bits to “1” according to the tag array can be written as:

Memory (Row)=Memory (Row)|Tag

Selective setting of bits to “0” according to the tag array can be written as:

Memory (Row)=Memory (Row) & ˜Tag

The operation described above uses flexible access to individual bits of the given row. In some embodiments, however, such flexible access is not available, and it is only possible to write complete 32-bit values en-bloc. In these embodiments, additional hardware can be added to perform a read-modify-write operation, which reads a 32-bit value from the memory array, modifies the appropriate bits and writes the result back to the memory.

The operations described in this section are sufficient for implementing a wide variety of mathematical operators such as addition, subtraction, equality checking, magnitude comparison and many others. For example, the “plus” function described above can be implemented in hardware using the parallel COMPARE and WRITE operations described in this section.

It can be shown that the hardware implementation of the “plus” function sums two 8-bit vectors in 320 clock cycles. The truth table has eight entries. Processing each entry uses 3 bits of COMPARE and 2 bits of WRITE. This process is repeated eight times over for the eight bitslices, to produce a total of 8*3*2*8=320 cycles. Using certain optimizations, the number of cycles can be reduced to 160. During these 160 cycles, the system performs 2048 additions. Thus, on average, the system performs 2048/160=12.8 additions per cycle. Moreover, some memory configurations (e.g. some static RAM devices) may comprise 262,144 columns of memory. In such configurations the system performs 1,638 additions per clock cycle.

Additionally or alternatively to accelerating the addition or multiplication operation, system 40 can provide other types of high-performance parallel operations, such as arithmetic, comparison and/or conditional operations. System 40 can be viewed as a full Turing machine combined with an Arithmetic Logic Unit (ALU) per each column of the memory array. System 40 thus achieves an extremely high level of parallelism and performance using conventional memory, and a small amount of hardware logic attached to the memory array. It should be noted that these parallel operations are carried out between the memory array, the tag array and the control logic. The CPU is usually transparent to this parallelism, and typically uses conventional 32-bit instructions over a conventional bus.

In some embodiments, system 40 supports a number of additional operations in order to add flexibility and efficiency. For example, the system may support a parallel write COPYTAG operation, which copies the entire tag array to a given memory row. This operation writes both “1” and “0” values of the tag array, and overwrites the previous values of the memory row. The COPYTAG operation can be written as:

Memory (Row)=Tag

The COPYTAG operation can also be given an inversion option. This option can be written as:

Memory (Row)=˜Tag

Additionally or alternatively, the system may support a parallel write SET operation, which sets a given row of the memory array to all “1”s or all “0”s irrespective of the tag array. The SET operation can be written as:

Memory (Row)=1

or

Memory (Row)=0

Further additionally or alternatively, system 40 may support a parallel shift tag operation, which allows interaction between data in different elements. The parallel shift tag operation sets the value of each bit in the tag array to the value of its nearest neighbor to the right or left.

The parallel operations described herein do not require data to be returned to the CPU. Typically, the CPU merely instructs the control logic as to which operations to execute between the memory array and the tag array, when to invert the data and which row of memory to operate on. Thus, from the perspective of the CPU, these operations are viewed as write operations and not read operations.

The following description defines an exemplary command interface, which can be used between the CPU and the control logic. The different instructions of the interface are implemented as memory instructions, i.e., take the form of either a memory load or store (read or write). Memory access instructions comprise two parameters: address and data. In a store instruction, both address and data are provided. In a load instruction, the address is provided and the data read from this address is returned.

The command interface also differentiates between classic-mode and parallel-mode operations, when system 40 operates in dual-mode. Classic-mode instructions comprise read and write requests for data having 32-bit width, as is well known in the art. The address specified in a classic-mode instruction, in the present example a 15-bit address, is broken down to a 9-bit Row Address Select (RAS) and a 6-bit word locator. Parallel-mode instructions comprise memory read and write requests for the parallel operations described herein.

In some embodiments, the differentiation between classic-mode and parallel-mode instructions is made by allocating separate address ranges for each mode. In the exemplary command interface, addresses in the range 0 to 0x7fff indicate classic-mode instructions. Thus, the command load (0x4000) will return the 32-bit word at address 0x4000. This word actually comprises the first 32 bits of the 2048-bit row at row number 256. Store (0x4001, 0xffff) will write a value of 0xfff to bits 32-63 of row 256. As noted above, 0x8000 represents fifteen bits, of which the nine MSBs select the row and the six LSBs select the word within the row.

Addresses outside the classic-mode range indicate parallel operations. An example of such a scheme is shown in the following table:

| Address | Operation |
|---|---|
| 0x000 | Classic mode operation |
| 0x080 | Parallel read COPY operation |
| 0x100 | Parallel read AND operation |
| 0x180 | Parallel read INVADD operation |
| 0x200 | Parallel write SETBYTAG operation: set 1 |
| 0x280 | Parallel write SETBYTAG operation: set 0 |
| 0x300 | Parallel write COPYTAG operation |
| 0x380 | Parallel write COPYTAG operation - invert |
| | Tag |
| 0x400 | Parallel write SET operation: set 1 |
| 0x480 | Parallel write SET operation: set 0 |
| 0x500 | Parallel shift Tag Array left |
| 0x580 | Parallel shift Tag Array right |

The addresses in the table are encoded in 4 bits, which are positioned above the base 15 address bits at addresses 16 to 19 of the address value. Bits 6 to 15 represent the row select, for both classic and parallel operations. Bits 0 to 5 are meaningful only for classic mode operations, and are ignored in parallel operations. By writing any value to the data address formed as above one can select any classic or parallel operation as well as the specific row to operate on. For memory arrays that are wider or deeper, a higher number of bits may be used for classic mode, and these bits may be encoded higher-up in the address value.

In alternative embodiments, the interface between CPU 44 and control logic 52 may differentiate between classic mode and parallel mode commands using any other suitable method, such as by using different op-codes for the different modes.

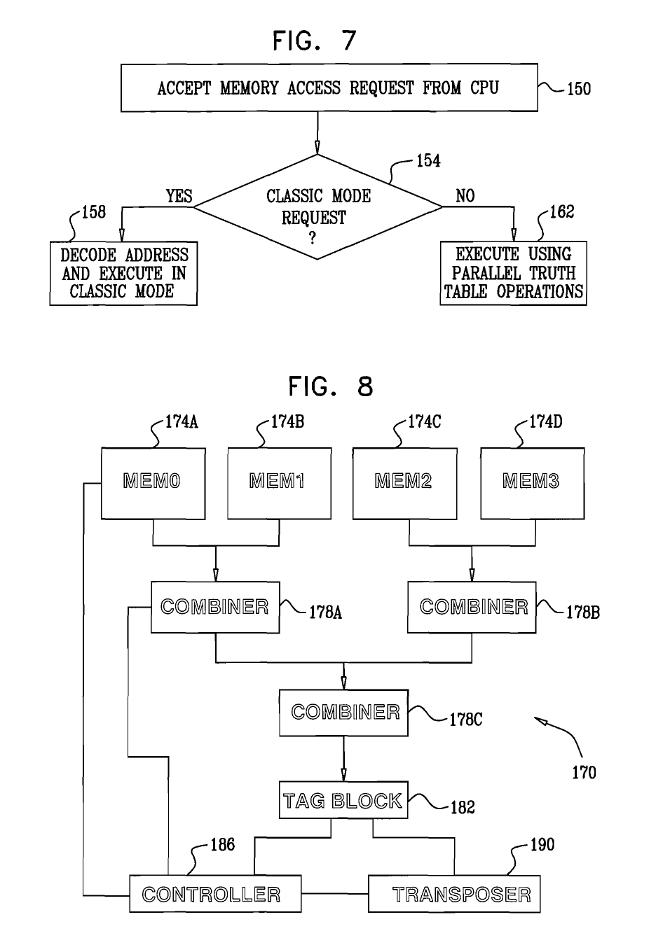

FIG. 7 is a flow chart that schematically illustrates a method for dual-mode operation in system 40, in accordance with an embodiment of the present invention. The method begins with control logic 52 accepting a memory access request from CPU 44, at a request acceptance step 150. The control logic checks whether the request is to be handled using classic mode or parallel mode, at a mode checking step 154. If the request is for a classic mode operation, logic 52 executes the request in classic mode, at a classic mode execution step 158. Otherwise, the control logic executes the request in parallel mode, at a parallel mode execution step 162.

The parallel processing methods described herein do not compromise the efficiency of using the memory for conventional serial read and write operations. Consider, for example, a 32-bit addition operation. This operation can be implemented by either (1) implementing a 32-bit adder, or (2) implementing a bit-wise adder and running the 32 bits through this adder in succession. The bit-wise adder configuration requires much fewer transistors (less than 1/32 in our example) than the 32-bit adder configuration. The 32-bit adder configuration, on the other hand, is much faster. Thus, there exists a time-space implementation trade-off. For massively-parallel architectures, the trade-off often favors the bit-wise implementation, such as because of simplicity and repeatability. The methods and systems described herein thus allow a natural fit between memory and bit-wise processing solutions.

### Performance Improvement Using Multiple Memory Banks

A possible disadvantage of the hardware implementation described in the previous section is the fact that the parallel COMPARE function uses a number of instruction cycles that is equal to the number of bits in the bit pattern to be compared. The description that follows presents an alternative configuration, which reduces the number of instruction cycles needed for performing the parallel COMPARE and WRITE operations. The configuration described below enables comparing a 4-bit pattern, or writing four bitslices, in a single instruction cycle. The disclosed configuration can be generalized in a straightforward manner to provide an even higher level of parallelism.

FIG. 8 is a block diagram that schematically illustrates a system 170 for data storage and processing, in accordance with an alternative embodiment of the present invention. System 170 comprises four memory arrays 174A . . . 174D, which are also referred to as memory banks. Each memory bank is similar to memory array 48 of FIG. 3 above, i.e., comprises 2048 columns and 512 rows that can be selected through an address decoder.

System 170 comprises combiners 178A . . . 178C. Each combiner has two inputs and one output. Each combiner accepts two 2048-bit rows at its two inputs, conditionally inverts any of the input rows, performs bit-wise AND between the two (possibly-inverted) rows, and outputs the result. System 170 further comprises a 2048-bit tag block 182, which is similar to tag array 64 of FIG. 3 above. The tag block accepts a 2048-bit row produced by combiner 178C. A controller 186 controls the memory banks, the combiners, the tag block and the transposer. In particular, the controller determines which memory banks are to perform read operations and which read results are to be inverted by the combiners.

The operation of system 170 will be demonstrated using an example, which processes four 2048-bit vectors. The elements of each vector have different numbers of bitslices (i.e., different lengths or precisions). The first two vectors, denoted A and B, have elements of precision 8 (i.e., each of A and B comprises eight bitslices). Vectors C and M are 1-bit vectors (i.e., C and M comprise single bitslices). Such an arrangement is typical when performing addition on the elements of vectors B and A, using C as a carry. M is used as an array of markers, such that elements of M whose value is “1” indicate that the corresponding elements of A and B are to participate in the addition operation, and elements of M whose value is “0” indicate that addition should not be performed on the corresponding elements of A and B. Each of the four vectors is stored in a different memory bank. Although A and B have precision 8, we will initially consider the LSBs of A and B, so that processing is actually applied to four separate bitslices. We will refer to these bitslices as A, B, C and M.

In order to perform addition using the methods described herein, system 170 first identifies the vector elements for which A and B are “1”, C is “0” and M is “1”. This action is equivalent to a parallel COMPARE across four bitslices for the bit pattern “1101”. System 170 reads the row containing each of the bitslices from each of the memory banks in the same instruction cycle. Note that the row address in each memory banks may be different. For A, B and M, the read 2048-bit row is provided by the appropriate combiner as input to the next stage. For C, the read 2048-bit row is inverted before passing it to the next stage. The combiners perform an AND operation between the respective bits. The output of the AND operation is written to the tag block.

In other words, the joint operation of the three combiners performs a logical AND of the LSB elements of A, B, ˜C and D, to produce the LSB element of the result. Corresponding bits of different orders from the four vectors are combined similarly. The end result is a 2048-bit output row that is written into the tag block. The memory read, inversion and combination operations are all performed within the same instruction cycle. The resulting operation is thus a 4-bit parallel COMPARE that is performed in a single instruction cycle.

The constraint, however, is that the four bitslices that participate in the operation are to be stored in different memory banks. In alternative embodiments, comparison operations between bitslices of the same memory bank can be performed in multiple instruction cycles. Alternately, if the two bitslices to be compared are initially stored in the same memory bank, one of them can be copied to another bank before the operation.

A similar performance gain is provided in parallel WRITE operations, as well. Three different variants of the parallel WRITE operations were discussed above: SET, COPYTAG and SETBYTAG. Each of these variants can be performed on each of the four memory banks in parallel. The result is that four bitslices can be set in a single clock cycle.

For example, assume that the tag block has been set as desired by a previous COMPARE operation, and the tag is now to be copied to a given row in memory bank 174A. Assume also that a certain row of memory bank 174B is to be set to all “1”s, that a “1” is to be written to each element in a certain row of memory bank 174C if the respective tag bits are “1”, and that a “0” is to be written to each element of yet another row of memory bank 174D if the respective tag bit is “1”. Using the configuration of FIG. 8, all four operations can be performed simultaneously in the same cycle under the control of controller 186. Yet another operation that controller 186 can perform is shifting of the tag block left and right.

Controller 186 is driven by instructions from the CPU (not shown in the figure). Thus, as in the configuration of FIG. 3 above, the CPU can provide memory-mapped instructions to the controller. The CPU may send addresses conforming to the actual memory address range, in which case it expects classic mode read and write operations to be performed. The CPU may send addresses outside of the physical address range. In this case, controller 186 interprets the addresses and translates them into control signals to the memory banks, combiners and tag block. These control signals invoke the different memory banks to perform the appropriate read and write operations. In the combiners, the control signals cause conditional data inversions, AND operations, write operations to the tag block, read operations from the tag block, as well as setting, copying or selective writing to the memory banks. In the tag block, the control signal trigger passing through of read data to the CPU, providing the content of the tag block to the combiners and/or shift operations.

Controller 186 is also responsible for providing classic mode read and write instructions. The controller may at least provide a bypass of classic mode access to the memory banks. In some embodiments, the controller may treat such classic mode operations as a separate control mode, and control the other elements of system 170 accordingly.

In some embodiments, system 170 further comprises a transposer 190, which accelerates the data transposition and re-transposition process described above. The transposer is optional and may be omitted in some implementations.

To conclude the present description, a summation operation of two vectors will be reviewed in light of the configuration of FIG. 8. In addition to vectors A, B, C and M, a vector O of precision 9 bits is now added. A and are stored at different locations in memory bank 174A. Vectors B, C and M are stored in memory banks 174B, 174C and 174D, respectively. System 170 executes five of the lines in the truth table of the addition operation. For each truth table entry, the system performs a COMPARE operation using the pattern of that entry on one bitslice from A, B, C and M. (The bits of M are to be set to “1” besides the entry in the truth table). If the pattern matches these four bits (i.e., if the corresponding tag bit after the COMPARE operation is “1”), the system sets a specific value to O and C.

The COMPARE operation reads from the four memory banks, and the WRITE operation writes to two of the memory banks. These operations use two instruction cycles. For comparison, performing the same operations using the configuration of FIG. 3 above would require four separate read instruction cycles for the COMPARE operation, and another two cycles for the WRITE operation. Thus, the configuration of FIG. 8 achieves a three-fold performance increase over the single-bank implementation of FIG. 3. To complete the addition operation, the process above is repeated over five truth table entries, requiring ten clock cycles. For 8-bit precision, 80 cycles are required. This figure is compared with the 240 cycles used by the single-bank implementation of FIG. 3.

### Tag-Less Configuration

In some embodiments, a system similar to system 170 can be implemented without the use of a tag block. Instead, one or more rows in one of the memory banks can be used for storing tag bit values. This system configuration is referred to as a tag-less system. In general, all of the methods and systems described herein can be carried out either with a designated tag register, with multiple tag registers, or with one or more rows of the memory that function as tag registers. All of these elements are referred to herein as different embodiments of a tag memory.

Tag-less configurations can be advantageous for a number of reasons. The register bits implementing the tag block are costly in terms of the hardware is added per each bit line of the memory array. Moreover, instead of using one cycle for reading the result of the COMPARE operation into the tag block and another cycle for reading the tag block back into the memory array, the result can be read directly from one memory bank to another. Yet another benefit is that multiple tag arrays can be stored and operations can even be performed between these tag arrays.

In the description of FIG. 8, the results of a COMPARE operation were written to tag block 182. In the tag-less configuration, the results of the COMPARE operation are written to one of the memory banks instead. For example, a fifth memory bank (having the same dimensions as the other four banks) can be added to the configuration of FIG. 8. A COMPARE operation would comprise reading in parallel from each of the first four memory banks, providing the read results to the combiners (while inverting and performing AND as required). However, the output of the combiners is written to a designated row in the fifth memory bank.

In some embodiments, each COMPARE operation in a sequence of COMPARE operations can be written to a different row. It may be advantageous to store each of these results separately, rather than having to erase each result before storing the next as in the configuration of FIG. 8. Each of these results can be regarded as a “virtual tag”. In some cases, the result written to the virtual tag is not an interim result in the calculation but the actual desired result of the calculation. In these cases, the operation can be completed in a single cycle, instead of the two cycles required with a separate tag block.

The fifth memory bank need not be dedicated to the virtual tag functionality. Virtual tags can be stored in any of the five memory banks, along with other data. The bank in which the virtual tag is stored may change from one operation to another.

Thus, the configuration of FIG. 8 can be extended by removing the constraint that any single cycle involves either a parallel read (COMPARE) or a parallel WRITE. The tag-less system specifies for each memory bank separately whether it will perform a read or a write. Moreover, any single cycle need not necessarily involve exactly four reads and one write. The logic can be generalized as follows: The results of the memory banks that are directed to perform a read are combined in an ADD operation. The result of the AND operation is used to determine each of the write operations.

Consider the following example: A COMPARE operation is performed on three memory banks. The result of the COMPARE operation is written directly to the fourth bank using a COPYTAG operation. Additionally, a “1” value is set for all bits in a row of the fifth memory bank wherever the result of the combined COMPARE is “1” (using the SETBYTAG operation).

As can be appreciated, there is no need to restrict the number of memory banks to four. For example, a system comprising six memory banks can sometimes be preferable. Consider the vector addition operation discussed above. Bitslices A, B, C and M can be in stored in the first four memory banks. Another copy of the carry bit, denoted C2, can be stored in the fifth memory bank and the output O in the sixth memory bank.

A COMPARE operation is performed on A, B, C and M. A “1” (or “0”) is written to C2 if the result of the COMPARE was “1”. A “1” (or “0”) is written to O if the result of the COMPARE is “1”. The decision whether to write “1” or “0” depends on the truth table entry. The decision may be different for C2 and for 0. Thus, an entire truth table entry can be processed in one cycle instead of two—one for the COMPARE and one for the WRITE. All five truth table entries can be processed in five cycles. An 8-bit precision addition will thus require a total of 40 cycles instead of 80.

In some embodiments, the tag-less system can operate with four memory banks at the expense of some performance degradation. In these embodiments, the system stores vectors A, B and C in the first three banks. The system defines a new bitslice, denoted T, for storing temporary results in the fourth memory banks. The system also stores 0 in the first memory bank, but in a different location. Similarly, the system stores M in the second memory banks. For each truth table entry, the system performs a COMPARE operation on A, B and C, and writes the result to T. In the next cycle, the system performs a COMPARE on T and M, and writes the result to C and O.

Although this configuration does not improve performance relative to the configuration of FIG. 8, it does demonstrate that no additional memory banks are required. Moreover, four memory banks will still improve performance for various other types of operations. For example, copying a vector from one location to another can be implemented using one cycle per bitslice instead of two.

A possible disadvantage of this configuration is that it may require two copies of some bitslices (such as the second copy of the carry bitslice in the example of the addition operation). This requirement arises from the constraint that any single memory bank can only be used for reading or writing in a given cycle. It is possible to add logic that enables the same memory bank to perform both reading writing in the same instruction cycle. The write is typically delayed, and therefore a read cannot be performed from it in the next cycle. However, a pipeline of write operations can be used without additional delays.

In the configurations of FIGS. 3 and 8, the system supported a function for shifting the tag array. This function can be supported in tag-less configurations, as well. For example, when a read operation is performed on a certain memory bank, the system can read the result of the bit to the left of the bit it would usually read. Thus, if bitslice A is represented as Aᵢ {i=0, 1, 2 . . . n}, wherein n is the number of elements in the array (e.g., 2048), we normally operate on Aᵢ. the read result would be written as:

Resultᵢ=Aᵢ & Bᵢ

However, if we read i−1, the result would be:

Resultᵢ=Aᵢ−1 & Bᵢ

This result is equivalent to reading A into the tag array, shifting the tag array to the right, writing the content of the tag array back to the memory array, performing a COMPARE, and writing the result back to the tag array, which would in turn be written back to another position in the memory array. As can be appreciated, a large number of operations can be smoothly integrated into one instruction cycle.

Shifting the tag array often plays an important role in the data transposition process. As part of the transposition process described in FIGS. 5 and 6, a source bitslice is copied to the tag, the tag is shifted to the right, the sifted tag is compared with a marker that has a “1” every eighth element, and the result is written back to the destination bitslice. This operation can be simplified by using a second tag array. In this configuration, the marker is stored in the second tag array, the source bitslice is moved to the first tag array, an AND is performed between the two tags, and the result is written to the destination bitslice.

On the other hand, implementing two tags may complicate the logic of the system. By allowing a read-from-left (Aᵢ−1) and a read-from-write (Aᵢ+1) in addition to the regular read operation, two-tag functionality can be performed without having to perform multiple writes to the memory array. In many practical cases, this configuration provides a five-fold performance increase over single-tag implementations. A typical single-tag implementation uses five cycles for each bit:

Copy the data to the tag.

Shift the tag.

Write the tag back to the array (e.g., to T).

Perform a COMPARE between T and ONE_EVERY_EIGHT.

Write the data to the destination.

In the tag-less system configuration, the data is shifted, compared with ONE_EVERY_EIGHT and written to the destination in the same clock cycle, thus providing a five-fold performance increase.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. A method for data processing, comprising:
accepting input data words comprising bits for storage in a memory that includes multiple memory cells arranged in rows and columns;
storing the accepted data words so that the bits of each data word are stored in more than a single row of the memory; and
performing a data processing operation on the stored data words by applying a sequence of one or more bit-wise operations to at least one row of the memory, so as to produce a result that is stored in one or more of the rows of the memory.

2. The method according to claim 1, wherein storing the input data words comprises transposing the input data words.

3. The method according to claim 2, wherein storing the input data words comprises initially writing the accepted data words to a first set of source rows of the memory, wherein the transposed data words are stored in a second set of destination rows of the memory, and wherein transposing the data words comprises reading the source rows sequentially and copying bits of the data words from each read source row to the destination rows.

4. The method according to claim 1, and comprising transposing at least the one or more of the rows storing the result, so as to provide at least one output data word in a respective row of the memory.

5. The method according to claim 1, wherein applying the sequence of the bit-wise operations comprises:
identifying subsets of the columns, such that for each column in a given subset, a sub-column of bits belonging to the column and to the at least one row matches an input bit pattern that is associated with the given subset; and
for each subset, writing a respective output bit pattern mapped to the input bit pattern associated with the subset to the memory cells of the one or more of the rows in the columns of the subset.

6. The method according to claim 5, wherein writing the output bit pattern comprises determining the output bit pattern responsively to the input bit pattern by looking-up a truth table that maps input bit patterns to respective output bit patterns.

7. The method according to claim 6, wherein looking-up the truth table comprises determining the output bit patterns for the respective columns by querying the truth table in parallel using the respective input bit patterns.

8. The method according to claim 5, wherein identifying the subsets comprises setting bits of a tag memory that correspond to the columns of a given subset, and wherein writing the output bit pattern mapped to the input bit pattern associated with the given subset comprises writing the output bit pattern to the columns for which the bits of the tag memory have been set.

9. The method according to claim 8, wherein the tag memory comprises one of a hardware register and a designated row of the memory.

10. The method according to claim 8, wherein writing the output bit pattern comprises performing at least one selective writing operation selected from a group of operations consisting of:
writing a “1” value to the columns for which the bits of the tag memory have been set; and
writing a “0” value to the columns for which the bits of the tag memory have been set.

11. The method according to claim 1, wherein the data processing operation comprises one of a logical operation, an arithmetic operation, a conditional execution operation and a flow control operation.

12. The method according to claim 1, and comprising receiving a request, classifying the request to one of a first type of requests for performing parallel data processing operations and a second type of requests for performing memory access operations on the memory, performing the data processing operation responsively to classifying the request to the first type and performing the memory access operation responsively to classifying the request to the second type.

13. The method according to claim 12, wherein classifying the request comprises extracting an address from the request and classifying the request based on the extracted address.

14. The method according to claim 1, wherein applying the bit-wise operations comprises performing at least one bit-wise operation selected from a group of operations consisting of:
copying bits from a row of the memory to respective bits of a tag memory;
copying the bits of the tag memory to the respective bits of the row of the memory;
reading the bits from the row of the memory, performing a bit-wise AND operation between the read bits and the respective bits of the tag memory, and writing respective output bits of the bit-wise AND operation to the bits of the tag memory;
reading the bits from the row of the memory, performing a bit-wise OR operation between the read bits and the respective bits of the tag memory, and writing respective output bits of the bit-wise OR operation to the bits of the tag memory; and
reading the bits from the row of the memory, applying bit-wise inversion to the read bits, performing a bit-wise AND operation between the inverted bits and the respective bits of the tag memory, and writing the respective output bits of the bit-wise AND operation to the bits of the tag memory.

15. The method according to claim 1, wherein applying the bit-wise operations comprises performing at least one bit-wise operation selected from a group of operations consisting of:
setting a row of the memory to all “0”s or to all “1”s;
conditionally setting a group of bits in a row of the memory to all “0”s or to all “1”s responsively to respective bits of a tag memory; and
applying a bit-wise shift to the bits of the tag memory.

16. The method according to claim 1, wherein applying the bit-wise operations comprises addressing a group of bits in a row of the memory by setting a corresponding group of bits in a tag memory and performing a bit-wise operation that is defined conditionally on values of the bits of the tag memory.

17. The method according to claim 1, wherein the memory comprises multiple memory banks, wherein the at least one row comprises multiple rows that are stored in respective, different memory banks, and wherein performing the data processing operation comprises applying the bit-wise operations to the multiple rows in a single instruction cycle.

18. The method according to claim 17, wherein applying the bit-wise operation comprises reading first and second rows from respective, different first and second memory banks, and performing a bit-wise AND operation between corresponding bits in the first and second rows.

19. The method according to claim 18, and comprising inverting the bits of one or both of the first and second rows prior to performing the bit-wise AND operation.

20. The method according to claim 18, and comprising writing an output of the bit-wise AND operation to a tag memory.

21. The method according to claim 18, and comprising storing an output of the bit-wise AND operation to one of:
one of the rows of the first memory bank;
one of the rows of the second memory bank; and
one of the rows of a third memory bank that is different from the first and second memory banks.

22. A method for data processing, comprising:
operating a memory device in a first operational mode for performing parallel data processing operations and in a second operational mode for performing memory access operations;
receiving a request, which specifies an address, for performing an operation on data stored in the memory device;
extracting the address from the request and selecting one of the first and second operational modes responsively to the extracted address; and
performing the requested operation by the memory device using the selected operational mode.

23. The method according to claim 22, wherein operating the memory device comprises predefining respective first and second address ranges for the first and second operational modes, and wherein selecting the one of the operational modes comprises determining one of the predefined address ranges in which the extracted address falls, and selecting the corresponding operational mode.

24. A data processing apparatus, comprising:
a memory, which comprises multiple memory cells arranged in rows and columns; and
control circuitry, which is connected to the memory and is coupled to accept input data words comprising bits for storage in the memory, to store the accepted data words so that the bits of each data word are stored in more than a single row of the memory, and to perform a data processing operation on the stored data words by applying a sequence of one or more bit-wise operations to at least one row of the memory, so as to produce a result that is stored in one or more of the rows of the memory.

25. The apparatus according to claim 24, wherein the control circuitry is coupled to transpose the input data words so as to store the bits of each data word in the more than the single row.

26. The apparatus according to claim 25, wherein the control circuitry is coupled to initially write the accepted data words to a first set of source rows of the memory, to store the transposed data words in a second set of destination rows of the memory, and to transpose the data words by reading the source rows sequentially and copying bits of the data words from each read source row to the destination rows.

27. The apparatus according to claim 24, wherein the control circuitry is coupled to transpose at least the one or more of the rows storing the result, so as to provide at least one output data word in a respective row of the memory.

28. The apparatus according to claim 24, wherein the control circuitry is coupled to apply the sequence of the bit-wise operations by:
identifying subsets of the columns, such that for each column in a given subset, a sub-column of bits belonging to the column and to the at least one row matches an input bit pattern that is associated with the given subset; and
for each subset, writing a respective output bit pattern mapped to the input bit pattern associated with the subset to the memory cells of the one or more of the rows in the columns of the subset.

29. The apparatus according to claim 28, wherein the control circuitry comprises a truth table that maps input bit patterns to respective output bit patterns, and wherein the control circuitry is coupled to determine the output bit pattern responsively to the input bit pattern by looking-up the truth table.

30. The apparatus according to claim 29, wherein the control circuitry is coupled to determine the output bit patterns for the respective columns by querying the truth table in parallel using the respective input bit patterns.

31. The apparatus according to claim 28, and comprising a tag memory, which comprises tag bits corresponding to the respective columns of the memory, and wherein the control circuitry is coupled to set the tag bits that correspond to the columns of a given subset, and to write the output bit pattern mapped to the input bit pattern associated with the given subset by writing the output bit pattern to the columns for which the tag bits have been set.

32. The apparatus according to claim 31, wherein the tag memory comprises one of a hardware register and a designated row of the memory.

33. The apparatus according to claim 31, wherein the control circuitry is coupled to write the output bit pattern by performing at least one selective writing operation selected from a group of operations consisting of:
writing a “1” value to the columns for which the bits of the tag memory have been set; and
writing a “0” value to the columns for which the bits of the tag memory have been set.

34. The apparatus according to claim 24, wherein the data processing operation comprises one of a logical operation, an arithmetic operation, a conditional execution operation and a flow control operation.

35. The apparatus according to claim 24, wherein the control circuitry is coupled to receive a request, to classify the request to one of a first type of requests for performing parallel data processing operations and a second type of requests for performing memory access operations on the memory, to perform the data processing operation responsively to classifying the request to the first type and to perform the memory access operation responsively to classifying the request to the second type.

36. The apparatus according to claim 35, wherein the control circuitry is coupled to extract an address from the request and to classify the request based on the extracted address.

37. The apparatus according to claim 24, and comprising a tag memory, which comprises tag bits corresponding to the respective columns of the memory, and wherein the control circuitry is coupled to perform at least one bit-wise operation selected from a group of operations consisting of:
copying bits from a row of the memory to the respective tag bits;
copying the tag bits to the respective bits of the row of the memory;
reading the bits from the row of the memory, performing a bit-wise AND operation between the read bits and the respective tag bits, and writing respective output bits of the bit-wise AND operation to the tag bits;
reading the bits from the row of the memory, performing a bit-wise OR operation between the read bits and the respective tag bits, and writing respective output bits of the bit-wise OR operation to the tag bits; and
reading the bits from the row of the memory, applying bit-wise inversion to the read bits, performing a bit-wise AND operation between the inverted bits and the respective tag bits, and writing the respective output bits of the bit-wise AND operation to the tag bits.

38. The apparatus according to claim 24, and comprising a tag memory, which comprises tag bits corresponding to the respective columns of the memory, and wherein the control circuitry is coupled to perform at least one bit-wise operation selected from a group of operations consisting of:
setting a row of the memory to all “0”s or to all “1”s;
conditionally setting a group of bits in a row of the memory to all “0”s or to all “1”s responsively to the respective tag bits; and
applying a bit-wise shift to the tag bits.

39. The apparatus according to claim 24, and comprising a tag memory, which comprises tag bits corresponding to the respective columns of the memory, wherein the control circuitry is coupled to address a group of bits in a row of the memory by setting a corresponding group of the tag bits, and to perform a bit-wise operation that is defined conditionally on the tag bits.

40. The apparatus according to claim 24, wherein the memory comprises multiple memory banks, wherein the at least one row comprises multiple rows that are stored in respective, different memory banks, and wherein the control circuitry is coupled to apply the bit-wise operations to the multiple rows in a single instruction cycle.

41. The apparatus according to claim 40, wherein the control circuitry comprises combining circuitry, which is operative to access multiple rows of the respective memory banks, to conditionally apply bit-wise inversion to one or more of the multiple rows, and to perform a bit-wise AND operation among the conditionally-inverted rows so as to produce the result.

42. The apparatus according to claim 41, wherein the combining circuitry is operative to write the result to a tag memory.

43. The apparatus according to claim 41, wherein the combining circuitry is operative to write the result to one of the multiple memory banks.

44. The apparatus according to claim 24, wherein the control circuitry comprises multiple bit processing circuits that are associated with the respective columns of the memory and are coupled to concurrently perform the bit-wise operations.

45. The apparatus according to claim 24, and comprising a semiconductor die, wherein the memory and the control circuitry are fabricated on the semiconductor die.

46. The apparatus according to claim 24, and comprising a device package, wherein the memory and the control circuitry are packaged in the device package.

47. A data processing apparatus, comprising:
a memory; and
control circuitry, which is connected to the memory and is coupled to operate in a first operational mode for performing parallel data processing operations and in a second operational mode for performing memory access operations, to receive a request, which specifies an address, for performing an operation on data stored in the memory, to extract the address from the request, to select one of the first and second operational modes responsively to the extracted address, and to perform the requested operation using the selected operational mode.

48. The apparatus according to claim 47, wherein the control circuitry is coupled to predefine respective first and second address ranges for the first and second operational modes, to determine one of the predefined address ranges in which the extracted address falls, and to select the corresponding operational mode.

49. A computer software product for data processing, the product comprising a tangible computer-readable medium in which program instructions are stored, which instructions, when read by a computer that is connected to a memory that includes multiple memory cells arranged in rows and columns, cause the computer to accept input data words comprising bits for storage in the memory, to store the accepted data words so that the bits of each data word are stored in more than a single row of the memory, and to perform a data processing operation on the stored data words by applying a sequence of one or more bit-wise operations to at least one row of the memory, so as to produce a result that is stored in one or more of the rows of the memory.

50. A computer software product for data processing, the product comprising a tangible computer-readable medium in which program instructions are stored, which instructions, when read by a computer that is connected to a memory, cause the computer to operate in a first operational mode for performing parallel data processing operations and in a second operational mode for performing memory access operations, to receive a request, which specifies an address, for performing an operation on data stored in the memory, to extract the address from the request, to select one of the first and second operational modes responsively to the extracted address, and to perform the requested operation using the selected operational mode.
